(19) United States
(12) Patent Application Publication
(10) Pub. No.: US 2005/0282600 A1
(43) Pub. Date: Dec. 22, 2005

(54) Car stereo for communicating with portable music player using wired connection

(76) Inventor: William L. Paradice III, San Francisco, CA (US)

Correspondence Address: WILLIAM L. PARADICE, III, 2686 MCALLISTER STREET, SUITE 1, SAN FRANCISCO, CA, 94118, US

(21) Appl. No.: 10/874,524

(22) Filed: Jun. 22, 2004

(51) Int. Cl. H04B 1/20

(52) U.S. Cl. 455/575.9

(57) ABSTRACT

A car stereo adapted to be mounted in a vehicle includes a front surface having an I/O port that facilitates communication with an external portable music player using a wired connection. Audio signals generated by the portable music player are transmitted without noise or interference via the wired connection to the car stereo. The I/O port may also transmit control signals from the car stereo to the portable music player via the wired connection. For some embodiments, the car stereo's I/O port provides power to the portable music player via the wired connection. For one embodiment, the car stereo includes circuitry to convert audio signals generated by an integrated audio source such as a radio receiver into a digital file format capable of being stored in the portable music player.

### FIELD OF INVENTION

This invention relates generally to car stereos and specifically to a car stereo that communicates with an external portable music player via a wired connection provided on a front surface of the car stereo.

### DESCRIPTION OF RELATED ART

Most vehicles today are equipped with a car stereo for outputting audio signals such as music to one or more associated loudspeakers mounted within the vehicle for listening enjoyment by occupants of the vehicle. Car stereos typically include an AM/FM radio receiver that receives radio frequency transmissions, and often also include a compact disc (CD) and/or magnetic cassette tape player.

Recent advances in semiconductor technology have allowed relatively small, portable digital music players to store large numbers of audio files in a CD-quality digital format. For example, one version of the iPod® music player available from Apple Computer, Inc. includes a 40-gigabyte hard-drive that can store up to 10,000 songs in a device small enough to fit into a shirt pocket, thereby allowing consumers to carry and listen to vast music collections virtually anywhere. These portable digital music players typically transmit audio signals to a set of headphones through a conventional headphone jack provided on an exterior surface of the player.

With the increasing popularity of portable music players, some manufacturers have developed portable adaptors that allow audio signals generated by portable music players to be played using a car stereo, thereby allowing consumers to listen to music from a portable music player via loudspeakers provided within the vehicle. For one example, a tape cassette adaptor may be used to route audio signals output from the portable music player's headphone jack to the car stereo using the car stereo's magnetic tape cassette player. For another example, an FM radio transmitter adaptor may be used to transmit audio signals output from the portable music player's headphone jack to the car stereo's radio receiver using a predetermined radio frequency.

Although useful, prior these techniques are infamous for poor sound quality. For example, as known in the art, receiving audio signals via a magnetic tape cassette player may significantly degrade the sound quality of the audio signals, which is perhaps the primary reason for the tape cassette becoming an obsolete medium for music storage. Likewise, interference from high-powered transmissions from commercial radio stations may significantly degrade the clarity of audio signals transmitted from the portable music player via the FM transmitter adaptor, especially in urban areas where broadcast radio transmissions are strong and where the radio frequency spectrum is crowded.

Thus, it would be desirable to transmit audio signals from a portable music player to a car stereo in a convenient manner without degradation of sound quality.

### BRIEF DESCRIPTION OF THE DRAWINGS

FIG. 1 is an exploded perspective view of an audio system including a portable music player coupled via a wired connection to a car stereo configured in accordance with various aspects of the present invention; and

FIGS. 2A-2D are simplified functional block diagrams of various exemplary embodiments of the car stereo of FIG. 1.

Like reference numerals refer to corresponding parts throughout the drawing figures.

### DETAILED DESCRIPTION

A system for transmitting audio signals from a portable music player to a car stereo is discussed below in the context of an exemplary car stereo for simplicity only. It is to be understood that embodiments of the present invention are equally applicable to car stereos having other features, architectures, user interface configurations, and the like. In the following description, for purposes of explanation, specific nomenclature is set forth to provide a thorough understanding of the present invention. However, it will be apparent to one skilled in the art that these specific details may not be required to practice the present invention. In other instances, well-known circuits and devices are shown in block diagram form to avoid obscuring the present invention unnecessarily. Additionally, the interconnection between circuit elements or blocks may be shown as buses or as single signal lines. Each of the buses may alternatively be a single signal line, and each of the single signal lines may alternatively be a bus. Accordingly, the present invention is not to be construed as limited to specific examples described herein but rather includes within its scope all embodiments defined by the appended claims.

Embodiments of the present invention allow audio signals such as music to be transmitted from a portable music player over a wired connection to a car stereo mounted in a vehicle for listening enjoyment by occupants of the vehicle through one or more loudspeakers connected to the car stereo. The wired connection is a signal-carrying cable that transmits audio signals from the portable music player to the car stereo via an I/O port provided on the front surface of the car stereo, thereby allowing occupants of the vehicle to easily connect and disconnect the cable from the I/O port of the car stereo. By facilitating communication between the portable music player and the car stereo using the signal-carrying cable, car stereos in accordance with the present invention allow audio signals to be transmitted from the portable music player to the car stereo without any degradation in sound quality.

Present embodiments of the car stereo may also include an integrated audio playback component that may includes well-known devices such as a compact disc player, a tape cassette player, a radio receiver, and the like. For such embodiments, a user-generated mode select signal may be used to select either the integrated audio component or the portable music player as the input audio source from which the car stereo transmits audio signals to the loudspeakers.

For some embodiments, the car stereo is configured to transmit user-generated control signals to the portable music player via the signal-carrying cable so that occupants of the vehicle may control various operations of the portable music player using one or more control inputs provided on the front surface of the car stereo. Further, car stereos in accordance with the present invention may also be configured to provide power to the portable music player using a power cable connected between the car stereo's front surface and a suitable power terminal of the portable music player. For one embodiment, the same cable may be used to transmit audio signals and status information from the portable music player to the car stereo and to transmit control information and power from the car stereo to the portable music player.

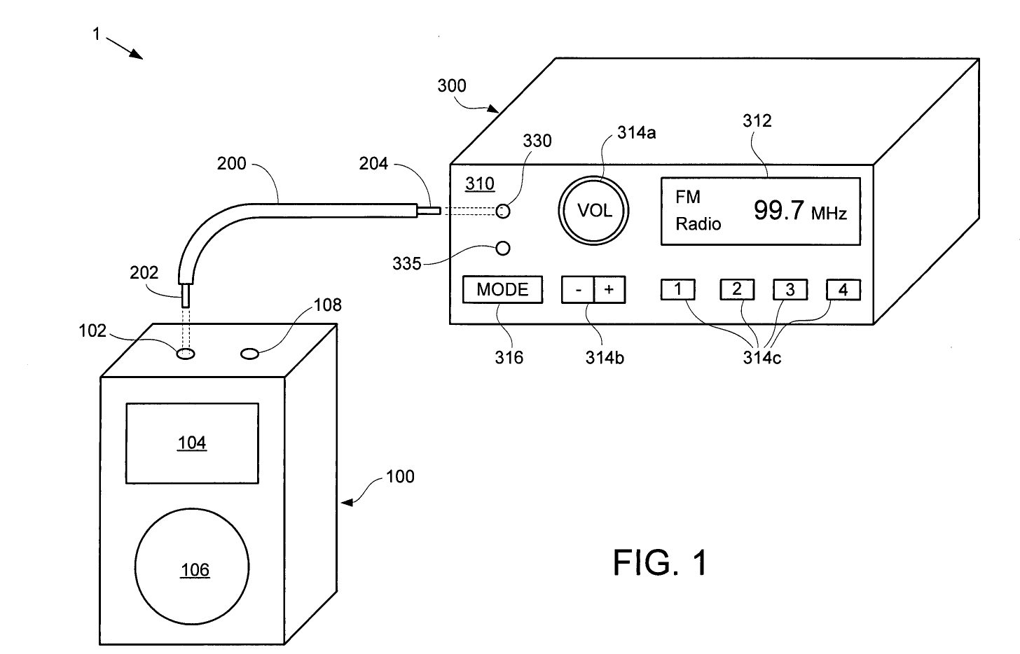

FIG. 1 shows an audio system 1 in accordance with one embodiment of the present invention. System 1 includes a portable music player 100, a cable 200, and a car stereo 300 configured in accordance with various aspects of the present invention. Car stereo 300 is capable of receiving audio signals via wired connection 200 from virtually any portable music player, including those having a hard-drive such as the iPod® music player, those having non-volatile memory such as Rio player from Diamond Multimedia, and those having removable storage mediums such as the Walkman® family of portable players from Sony Corporation. Thus, for purposes of discussion herein, portable music player 100 may be any well-known portable music player capable of outputting audio signals via a suitable output port.

Portable music player 100 is shown in FIG. 1 as including a headphone jack 102, a display 104, and a control mechanism 106. For simplicity, various well-known internal components of portable music player 100 such as integrated and/or removable storage mediums, control circuitry, audio reproduction units, power sources, and the like are shown in FIG. 1 or described herein. Headphone jack 102, which is well-known, is configured to mate and communicate with a set of headphones (not shown for simplicity) using well-known standardized connectors (e.g., the well-known mini connector plug) adopted by most manufacturers of portable music players. However, for other embodiments, headphone jack 102 may be of other configurations. Display 104, which is well-known, provides status information indicative of various operations of portable music player 100 such as, for example, the currently selected album title, track title and/or number, time elapsed and time remaining indications, and the like. Control mechanism 106, which is well-known, allows users to control various operations of portable music player, for example, such as selecting an album and/or track, track skipping and scanning, volume control, and start, stop, and pause commands.

For some commercially available portable music players, headphone jack 102 is configured to receive control signals that may be used to control various operations of the portable music player. For example, the iPod® player is typically sold with a headphone set having an input control panel that allows users to provide control signals to the player via its headphone jack 102 to control various operations of the player in a well-known manner.

As shown in FIG. 1, portable music player 100 may also include an auxiliary port 108 that may be used to receive power from an external power source via a suitable power connection. For some embodiments in which portable music player 100 is an ipod® player, auxiliary port 108 is configured to mate and communicate with a well-known fire-wire cable. As known in the art, the fire-wire cable can not only provide power to the ipod® player via auxiliary port 108 but also can be used to rapidly download audio files and other information to the iPod® via auxiliary port 108, for example, from a personal computer (not shown for simplicity). In addition, iPod® players may also output status, synchronization, and other control information via auxiliary port 108, for example, to a personal computer.

Cable 200, which may be any well-known flexible signal-carrying cable, includes a first end 202 adapted to mate and communicate with headphone jack 102 of portable music player 100, and includes a second end 204 adapted to mate and communicate with an I/O port 330 provided on a front surface 310 of car stereo 300. Thus, first cable end 202 may be of any suitable configuration that is compatible with headphone jack 102, and second cable end 204 may be of any suitable configuration that is compatible with the car stereo's I/O port 330. Cable 200 transmits audio signals received from portable music player 100 via its headphone jack 102 to car stereo 300 via its I/O port 330 without sound quality degradation typically inherent with previous techniques such as magnetic tape cassette adaptors and FM radio transmitters. For some embodiments, cable 200 may be used to transmit status information (e.g., such as that displayed on the portable music player's display 104) to car stereo 300 via its I/O port 330. In addition, cable 200 may be used to transmit control signals generated by car stereo 300 to portable music player 100 to control various operations of portable music player 100 using control inputs provided on car stereo 300. For other embodiments, cable 200 may be used to provide power from car stereo 300 to portable music player 100.

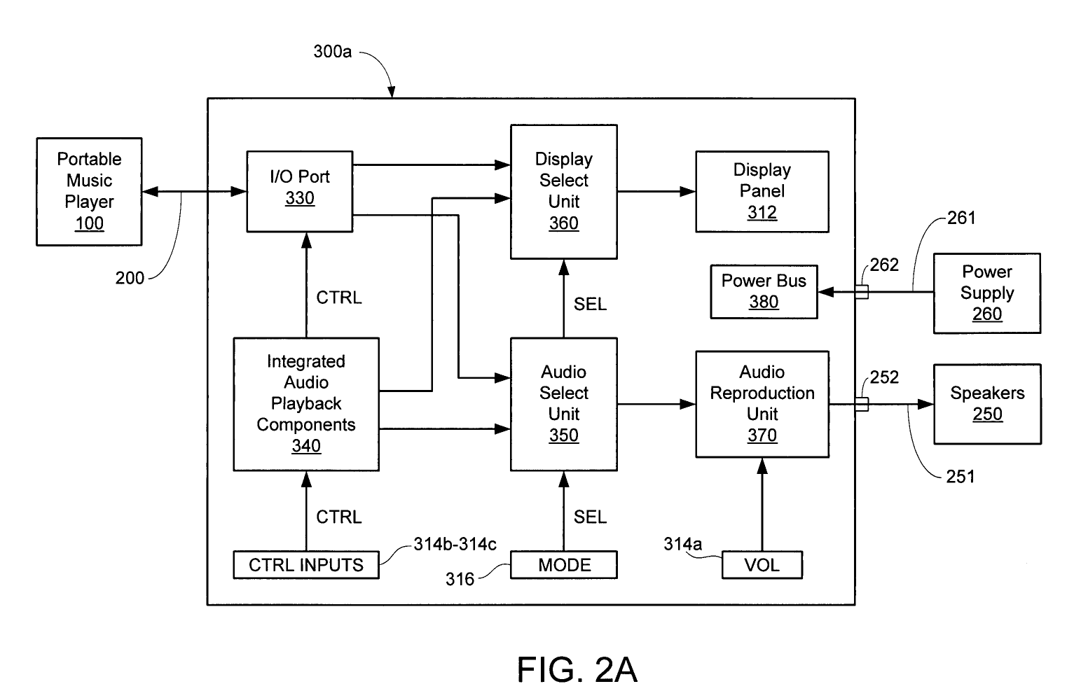

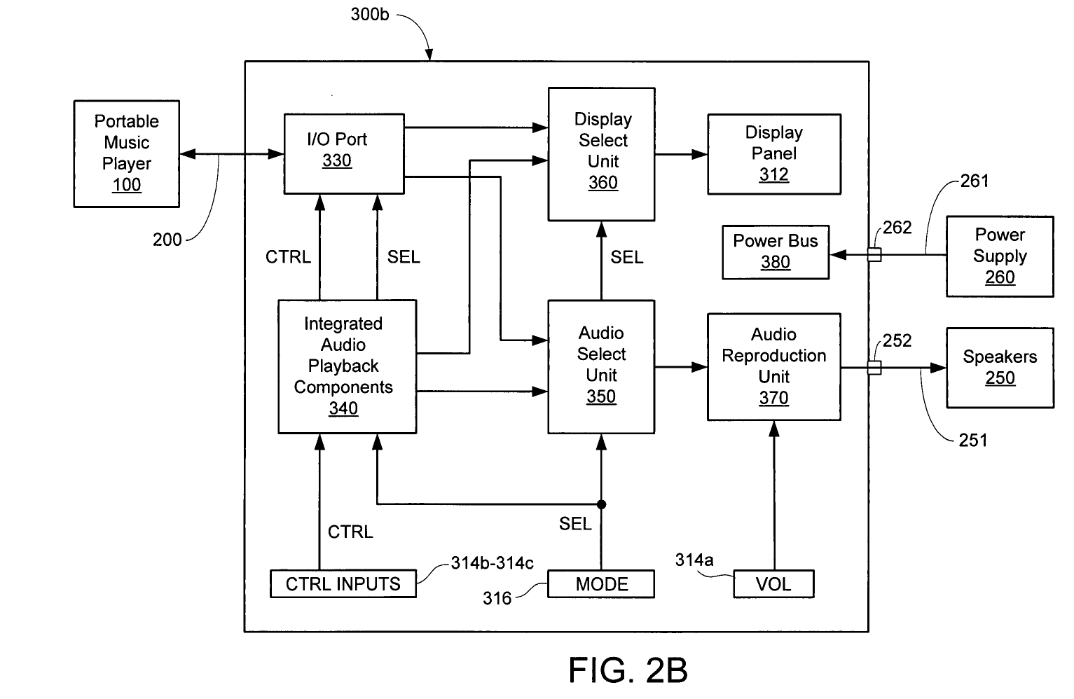

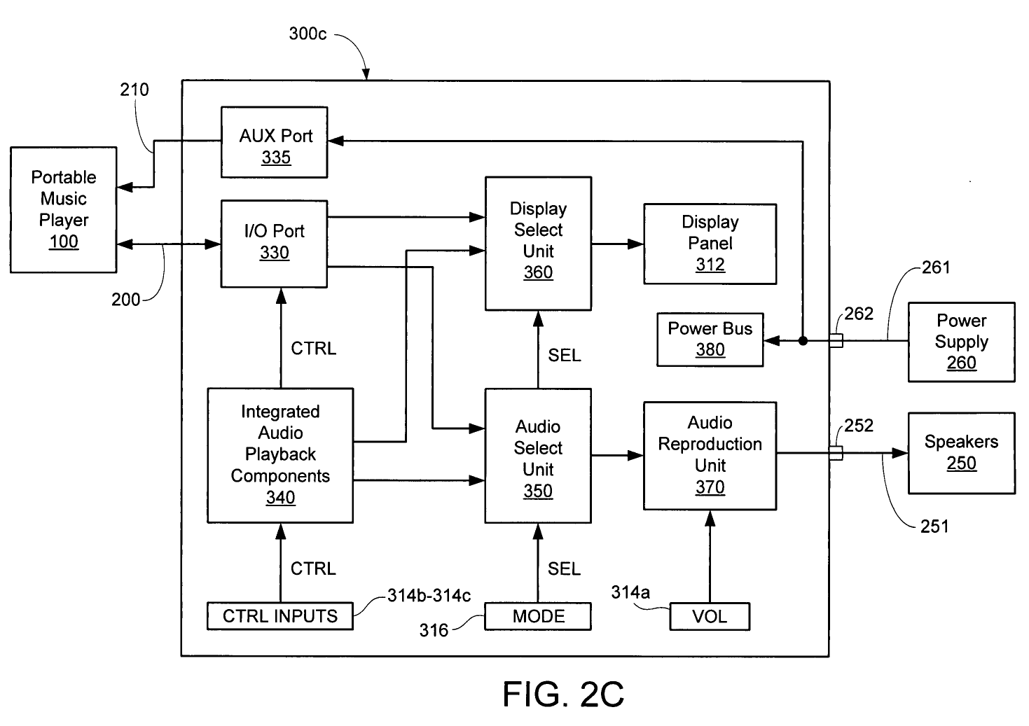

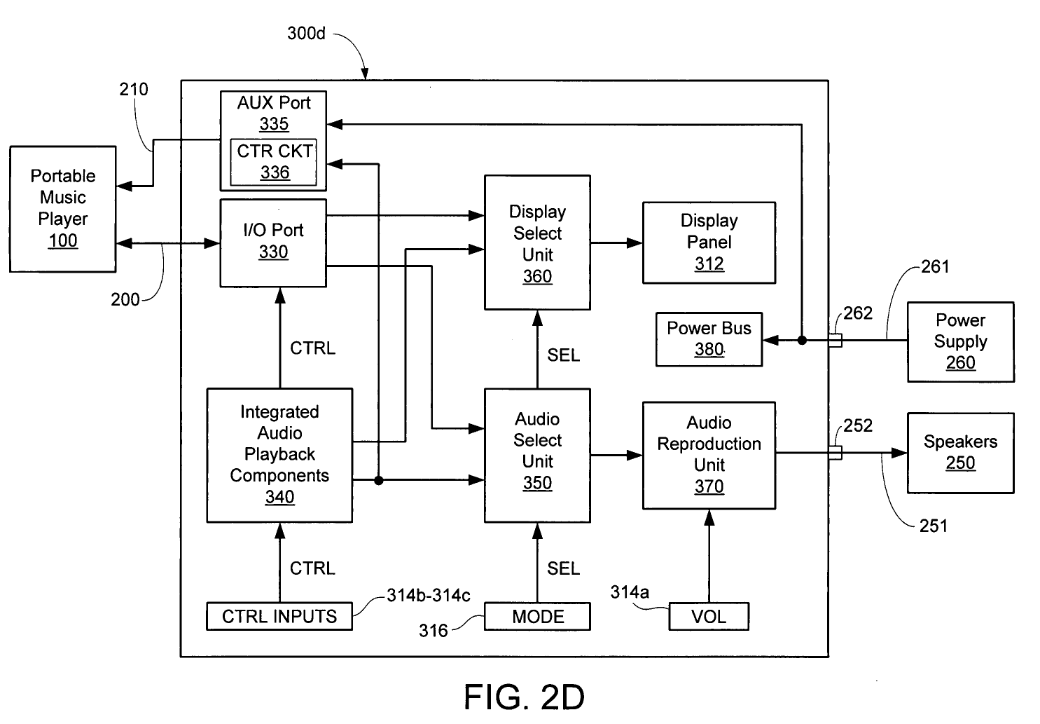

Car stereo 300 is adapted to be mounted within the dashboard or other suitable surface of a vehicle in a well-known manner. The front surface 310 of car stereo 300, which is readily accessible by the occupants of the vehicle (for simplicity, the vehicle and its occupants are not shown in the figures), is shown in the exemplary embodiment of FIG. 1 to include a display panel 312, control inputs 314a-314c, a mode select input 316, and I/O port 330. Although not shown in FIG. 1, car stereo 300 includes an audio reproduction unit, a power bus architecture, various control units, and an integrated audio playback component containing one or more well-known audio devices such as a compact disc player, a tape cassette player, a radio receiver, and the like, as described in more detail with respect to the functional block diagrams of FIGS. 2A-2D.

Further, although not shown in FIG. 1 for simplicity, a rear surface (which is neither visible to nor accessible by occupants of the vehicle) of car stereo 300 includes a well-known power port and well-known audio output ports. The power port is connected to a suitable external power supply (e.g., the vehicle's battery and/or alternator) via well-known power connections to provide power to various components within car stereo 300. The audio output ports are connected to one or more loudspeakers mounted within the vehicle via well-known electrical wiring. For simplicity, the external power supply, power connections, loudspeakers, and electrical wiring are not shown in FIG. 1.

As mentioned above, cable 200 mates with I/O port 330 on the car stereo's front surface 310, thereby advantageously allowing occupants of the vehicle to easily connect and disconnect cable 200 from car stereo 300 without removing car stereo 300 from its mounted positioned within the vehicle. I/O port 330 may be configured to communicate with any well-known signal-carrying cable, including RCA cables, universal serial bus (USB) connectors, fire-wire cables, and the like. Further, as mentioned above, transmitting audio signals from portable music player 100 to car stereo 300 using a wired connection such as cable 200 preserves the sound quality and clarity of audio signals generated by portable music player 100, thereby allowing users to broadcast music stored or otherwise contained within portable music player 100 over the vehicle's loudspeakers using car stereo 300 without any signal interference, noise, or other corruption in sound quality.

Control inputs 314a-314c may be used to control operation of one or more audio playback components integrated within car stereo 300, and for some embodiments may also be used to control various operations of portable music player 100 via cable 200. For the exemplary embodiment of FIG. 1, control input 314a is illustrated as a volume control knob that adjusts the volume of audio signals output from car stereo 300 to the vehicle's loudspeakers, control inputs 314b are illustrated as depressible buttons that implement various well-known functions such as radio frequency adjustments, track skip and scan commands, bass, treble, and fader controls, and the like, and control inputs 314c are illustrated as depressible buttons that may be used to implement other well-known controls such as selecting preset radio stations for the car stereo's radio receiver (not shown in FIG. 1). Mode select input 316, which is shown in the exemplary embodiment of FIG. 1 as a depressible button, is controlled by occupants of the vehicle to generate a select signal that selects either portable music player 100 or one of the integrated audio playback components as the input audio source from which car stereo 300 transmits audio signals to the loudspeakers.

Display panel 312 is well-known, and displays status information for various operations of car stereo 300. For one example, if a radio receiver is selected as the input audio source, display panel 312 may display status information such as the currently selected radio frequency, signal strength, and the like. For another example, if a compact disc player is selected as the input audio source, display panel 312 may display status information such as the currently selected track, time elapsed, time remaining, and the like. Further, as mentioned above, for some embodiments portable music player 100 may provide status information to car stereo 300 via cable 200. Thus, for such embodiments, display panel 312 may display status information provided by portable music player 100 via cable 200 when portable music player 100 is selected as the input audio source.

For the exemplary embodiment of FIG. 1, front surface 310 of car stereo 300 is shown to also include an auxiliary port 335 having a suitable configuration that enables connection to port 108 of portable music player 100 using a well-known power cable (not shown in FIG. 1 for simplicity) capable of providing power from car stereo 300 to portable music player 100. For some embodiments in which portable music player 100 is an iPod® player, auxiliary port 335 is a well-known fire-wire port adapted to be connected to port 108 of portable music player 100 via a well-known fire-wire cable (not shown in FIG. 1 for simplicity). For such embodiments, the fire-wire cable may provide power from car stereo 300 to portable music player 100 and, in addition, may also transmit audio signals and status information from portable music player 100 to car stereo 300. Further, for some embodiments, the fire-wire cable may be used to download audio signals generated within car stereo 300 (e.g., from one or more of the car stereo's integrated audio playback components) from auxiliary port 335 to portable music player 100 via its fire-wire port 108. For other embodiments, other types of cables suitable for power, audio signal, and control signal transmissions may be used. For still other embodiments, auxiliary port 335 may be eliminated.

The relative positioning of display panel 312, control inputs 314a-314c, mode select input 316, I/O port 330, and auxiliary port 335 as depicted in FIG. 1 is exemplary. For other embodiments, display panel 312, control inputs 314a-314c, mode select input 316, and ports 330 and 335 may be provided in other configurations. Similarly, the specific implementations of control inputs 314a-314c and mode select input 316 shown in FIG. 1 are merely illustrative, and may be altered for other embodiments. For example, although shown in FIG. 1 as a control knob, for other embodiments, volume control input 314a may be implemented using other suitable controls such as one or more depressible buttons, a sliding mechanism, a touch screen, a voice-activated control, and the like. Similarly, although shown in FIG. 1 as depressible buttons, for other embodiments, control inputs 314b-314c and mode select input 316 may be implemented using other suitable user input mechanisms such as switches, touch-screen controls, voice-activated controls, and the like.

FIG. 2A shows a car stereo 300a that is one exemplary embodiment of car stereo 300 of FIG. 1. Car stereo 300a is shown in FIG. 2A as including display panel 312, control inputs 314a-314c, I/O port 330, integrated audio playback components 340, an audio select unit 350, a display select unit 360, an audio reproduction unit 370, and a power bus system 380. I/O port 330 includes a first input to receive audio signals and status information from portable music player 100 via cable 200, a second input to receive control signals (CTRL) from control inputs 314b-314c, a first output connected to a first input of audio select unit 350, and a second output connected to a first input of display select unit 360. I/O port 330 provides audio signals received from portable music player 100 to audio select unit 350, and provides status information from portable music player 100 to display select unit 360.

For some embodiments, I/O port 330 provides control signals received from one or more control inputs 314 to the portable music player's headphone jack 102 via cable 200, thereby allowing occupants of the vehicle to control various operations (e.g., volume control, skip, scan, start, stop, and pause commands) via car stereo 300a. Controlling various operations of portable music player 100 using control signals provided to its headphone jack 102 may be implemented in a well-known manner, for example, such as that utilized by the well-known iPod® player.

Integrated audio playback components 340, which as mentioned above may include one or more well-known audio devices such as a radio receiver, CD player, tape cassette player, and the like, includes a first input to receive control signals from control inputs 314b-314c, a first output to provide audio signals to a second input of input select unit 350, and a second output to provide status information to a second input of display select unit 360. The configuration and operation of integrated audio playback components 340 is well-known, and therefore is not described in detail herein.

Audio select unit 350 includes an input to receive SEL from mode select input 316 and includes an output connected to an input of audio reproduction unit 370. In response to SEL, audio select unit 350 selectively transmits audio signals received from portable music player 100 via I/O port 330 or audio signals received from one of integrated audio playback components 340 to audio reproduction unit 370. For embodiments in which integrated audio components 340 include more than one well-known audio device, such as a radio receiver and a compact disc player, the select signal may also be used to select one of the audio devices represented by integrated audio components 340 as the input audio source.

Display select unit 360 includes an input to receive SEL from mode select input 316, and includes an output connected to an input of display panel 312. In response to SEL, display select circuit 360 selectively transmits status information generated by portable music player 100 via I/O port 330 or status information generated by integrated audio playback component 340 to display panel 312 for viewing by occupants of the vehicle.

For some embodiments, audio select unit 350 and display select unit 360 are well-known multiplexing circuits responsive to SEL. For one embodiment, audio select unit 350 and display select unit 360 may be formed as an integrated control unit that selectively provides audio signals and status information from either I/O port 330 or from integrated audio playback component 340 to audio reproduction unit 350 and display panel 360, respectively, in response to SEL.

Audio reproduction unit 370, which includes well-known components such as an audio amplifier, output drivers, frequency response control circuits, and the like, is configured to transmit audio signals received from audio select unit 350 to one or more loudspeakers 250 using well-known electrical wiring 251 connected between audio reproduction unit 370 and loudspeakers 250 via an audio output port 252 positioned on the rear surface of the car stereo. Audio reproduction unit 370 includes a control input to receive volume control signals from volume control input 314a and, in response thereto, selectively adjusts the volume of audio signals transmitted to loudspeakers 250. Although not shown for simplicity, for some embodiments, audio reproduction unit 370 may also receive other control signals to control the frequency response of the audio signals (e.g., bass, treble, and midrange adjustments), as well as fader control signals, from one or more corresponding control inputs 314 and/or from other control inputs (not shown for simplicity) provided on front surface 310 of the car stereo.

Power bus system 380 receives power from an external power supply 260 via a power cable 261 provided through a power port 262 provided on the rear surface of car stereo 300a. Power supply 260 may be any well-known power supply such as, for example, a battery provided within the vehicle. Power bus system 380, which may include various well-known power converters, bus systems, control circuitry, and the like, routes power to the internal components of car stereo 300a in a well-known manner. For simplicity, the individual power connections between power bus system 380 and various internal components of car stereo 300a are not shown for simplicity.

An exemplary operation of car stereo 300a is as follows. To select integrated audio playback component 340 as the input audio source, mode select input 316 is toggled (e.g., by an occupant of the vehicle) to assert SEL to a first state. In response to the first state of SEL, audio select unit 350 provides audio signals generated by integrated audio playback components 340 to audio reproduction unit 370, which in turn transmits the audio signals to loudspeakers 250 for listening by the vehicle's occupants. Similarly, in response to the first state of SEL, display select unit 360 forwards status information generated by integrated audio playback components 340 to display panel 312. In this state, control signals generated by control inputs 314b-314c may be used to control various well-known operations of integrated audio playback components 340.

To select portable music player 100 as the input audio source, mode select input 316 is toggled (e.g., by an occupant of the vehicle) to assert SEL to a second state. In response to the second state of SEL, audio select unit 350 provides audio signals generated by portable music player 100 and received by I/O port 330 to audio reproduction unit 370, which in turn transmits the audio signals to loudspeakers 250 for listening by the vehicle's occupants. Similarly, in response to the second state of SEL, display select unit 360 may forward status information generated by portable music player 100 via I/O port 330 to display panel 312. In this state, control signals generated by control inputs 314b-314c may be used to control various well-known operations of portable music player 100.

For other embodiments, SEL may be used to selectively enable and disable I/O port 330 and integrated audio playback components 340. For example, FIG. 2B shows a car stereo 300b that is another exemplary embodiment of car stereo 300 of FIG. 1. Car stereo 300b is similar to car stereo 300a of FIG. 2A, except that the select signal SEL generated by mode select input 316 is also provided to corresponding control inputs of I/O port 330 and integrated audio playback components 340. For the exemplary embodiment of FIG. 2B, the first state of SEL disables I/O port 330 from receiving audio signals and status information from portable music player 100 and enables integrated audio playback components 340 to generate output audio signals and status information, and the second state of SEL enables I/O port 330 to receive audio signals and status information from portable music player 100 and disables integrated audio playback components 340 from generating output audio signals and status information. For one embodiment, the first state of SEL powers down I/O port 330, and the second state of SEL powers down integrated audio playback components 340.

For other embodiments, display panel 312 may include an additional input to receive SEL. For such embodiments, display panel 312 may display information indicating the selected audio input source. For example, when SEL is in the first state, display panel 312 may indicate that a radio receiver is the selected audio input source, and when SEL is in the second state, display panel 312 may indicate that portable music player 100 is the selected audio input source.

For still other embodiments, integrated audio playback components 340, audio select unit 350, display select unit 360, and mode select input 316 may be eliminated, in which case I/O port 330 may be connected directly to audio reproduction unit 370 and display panel 312.

As described above, embodiments of the present invention allow audio signals to be transmitted from portable music player 100 to car stereo 300 for output on loudspeakers 250 using a wired connection 200, thereby eliminating sound quality degradation characteristic of prior tape cassette adaptors and FM radio transmitters. In this manner, embodiments of car stereo 300 allow consumers to listen to vast music collections stored in portable music players through a vehicle's loudspeakers without experiencing unreliable transmission qualities inherent in FM radio transmitter devices and/or infamous hissing noises inherent in magnetic cassette player adaptors. Further, because I/O port 330 is conveniently positioned on the front surface 310 of car stereo 300, occupants of the vehicle in which car stereo 300 is mounted may easily connect and disconnect portable music player 100 to and from car stereo 300, for example, without removing the car stereo from its mounted position in the vehicle. In addition, for some embodiments, car stereo 300 advantageously allows consumers to control operation of portable music player 100 using one or more control inputs 314a-314c conveniently positioned on the car stereo's front surface 310.

As mentioned above, some embodiments of car stereo 300 include an auxiliary port 335 positioned on the front surface 310 of the car stereo. For example, FIG. 2C shows a car stereo 300c that is another exemplary embodiment of car stereo 300 of FIG. 1. Car stereo 300c, which includes all the elements of car stereo 300a of FIG. 2A, is shown to include auxiliary port 335 having an input coupled to external power supply 260 via power connection 261 and having an output connected to portable music player 100 via a power cable 210. Power cable 210, which is connected to the portable music player's auxiliary port 108 and may be any suitable power cable having a first end adapted to mate with portable music player's auxiliary port 108 and having a second end adapted to mate with the car stereo's auxiliary port 335, provides power from external power supply 260 to portable music player 100 via car stereo 300c, thereby enabling portable music player 100 to operate for extended periods of time using the vehicle's power supply 260. By providing power to portable music player 100 from car stereo 300c using power cable 210, rather than using conventional power adaptors such as those which draw power from the vehicle's cigarette lighter outlet, embodiments of the present invention not only eliminate the need to purchase a separate power adaptor, but also allow the vehicle's cigarette lighter outlet to be used for other purposes.

As described above, for some embodiments, auxiliary port 335 of car stereo 300c may be adapted to mate with a fire-wire cable for providing power to compatible portable music players such as the iPod® player. Further, as known in the art, some portable music players such as the iPod® player can receive audio files from an external source using the fire-wire cable. Accordingly, car stereos in accordance with other embodiments of the present invention may include a fire-wire compatible auxiliary port 335 and associated circuitry that allows audio files generated by one or more integrated audio playback components 340 to be downloaded from the car stereo to the portable music player using a fire-wire cable.

For example, FIG. 2D shows a car stereo 300d that is another exemplary embodiment of car stereo 300. Car stereo 300d is similar to car stereo 330c of FIG. 2C, except that auxiliary port 335 also includes a control circuit 336 that may receive audio signals generated from integrated audio playback components 340. Control circuit 336 may be any well-known circuit that converts audio signals received from integrated audio playback components 340 into a format suitable for storage in a storage medium (e.g., a hard-disk, flash memory, EEPROM, memory card, and the like) provided within portable music player 100. For simplicity, the storage medium contained within portable music player 100 is not shown for simplicity. For example, control circuit 336 may convert audio signals received from integrated audio playback components 340 into well-known file formats such as WAV files, MPEG files, AAC files, and other digital audio formats capable of being stored in the portable music player's internal storage medium, and may transmit the suitably formatted audio files to portable music player 100 via fire-wire cable 210 or other suitable wired connection. In this manner, embodiments of the present invention allow audio signals generated by integrated audio playback components 340 to be transmitted to and stored in portable music player 100. For example, car stereo 300d may be used to convert radio transmissions (e.g., music) received by its radio receiver into a suitably formatted file that may subsequently be transmitted via fire-wire cable 210 to portable music player 100 for storage therein.

For some embodiments, control circuit 336 may include a select terminal (not shown for simplicity) to receive a user-provided file format select signal that instructs control circuit 336 into which file format the audio signals generated from integrated audio playback components 340 are to be converted. For such embodiments, an additional control input may be provided on the front surface 310 of car stereo 300d to generate the file format select signal.

For other embodiments, car stereo 300 may be connected to portable music player 100 using a single cable such as a fire-wire connection that not only provides power from car stereo 300 to portable music player 100 but also exchanges audio signals, status information, and control signals between car stereo 300 and portable music player 100, although other types of cable may be used.

While particular embodiments of the present invention have been shown and described, it will be obvious to those skilled in the art that changes and modifications may be made without departing from this invention in its broader aspects and, therefore, the appended claims are to encompass within their scope all such changes and modifications as fall within the true spirit and scope of this invention. For example, although described above as providing status information to car stereo 300 via I/O port 330 for viewing on display panel 312, for other embodiments portable music player 100 may not provide status information to car stereo 300. Similar, although described above as providing control signals from control inputs 314 to portable music player via wired connection 200, for embodiments car stereo may not provide control signals to portable music player 100.

1. A car stereo adapted to be mounted in a vehicle, comprising:
a front surface readily accessible by occupants of the vehicle;
an input/output (I/O) port provided on the front surface, the I/O port adapted to receive first audio signals from an external portable music player via a wired connection; and
an audio reproduction unit having an input to receive the first audio signals from the portable music player via the I/O port and having an output configured to transmit the first audio signals to one or more loudspeakers mounted within the vehicle.

2. The car stereo of claim 1, wherein the wired connection comprises a signal-carrying cable having a first end adapted to communicate with a headphone jack of the portable music player and having a second end adapted to communicate with the I/O port.

3. The car stereo of claim 1, wherein the wired connection comprises a universal serial bus cable.

4. The car stereo of claim 1, wherein the wired connection comprises a fire-wire cable.

5. The car stereo of claim 4, wherein the I/O port is configured to provide power to the portable music player via the fire-wire cable.

6. The car stereo of claim 5, further comprising:
an integrated audio playback component having an output;
an audio select unit having a first input connected to the I/O port, a second input connected to the output of the integrated audio playback component, an output connected to the input of the audio reproduction unit, and a control terminal to receive a select signal; and
a mode select input provided on the front surface of the car stereo, the mode select input for selectively driving the select signal to either a first state or a second state.

7. The car stereo of claim 6, wherein the integrated audio playback component consists of one or more of the following: a radio receiver, a compact disc player, and a cassette tape player.

8. The car stereo of claim 6, wherein the first state of the select signal causes the audio select unit to transmit the first audio signals generated by the portable music player to the audio reproduction unit, and the second state of the select signal causes the audio select unit to transmit second audio signals generated by the integrated audio playback component to the audio reproduction unit.

9. The car stereo of claim 7, wherein the first state of the select signal enables the I/O port and disables the integrated audio playback component, and the second state of the select signal disables the I/O port and enables the integrated audio playback component.

10. The car stereo of claim 6, further comprising:
a display panel provided on the front surface of the car stereo; and
a display select unit having a first input connected to a second output of the I/O port, a second input connected to a second output of the integrated audio playback component, an output connected to an input of the display panel, and a control terminal to receive the select signal.

11. The car stereo of claim 10, wherein the display select unit transmits first status information from the portable music player via the I/O port to the display panel when the select signal is in the first state, and transmits second status information from the integrated audio playback component to the display panel when the select signal is in a second state.

12. The car stereo of claim 1, wherein the I/O port is configured to transmit one or more control signals generated from one or more control inputs provided on the front surface of the car stereo to the portable music player via the wired connection, the one or more control signals for controlling various operations of the portable music player.

13. The car stereo of claim 1, further comprising an auxiliary port located on the front surface, the auxiliary port configured to communicate with a corresponding port of the portable music player using a fire-wire cable.

14. The car stereo of claim 13, wherein the auxiliary port is configured to provide power to the portable music player using the fire-wire cable.

15. The car stereo of claim 13, further comprising:
an integrated audio playback component having an output to generate second audio signals; and
a control circuit having an input to receive the second audio signals from the integrated audio playback component and having an output connected to the auxiliary port, the control circuit configured to convert the second audio signals into one of a plurality of digital file formats suitable for storage in the portable music player.

16. The car stereo of claim 15, wherein the digital files are transmitted from the auxiliary port of the car stereo to the portable music player via the fire-wire cable.

17. The car stereo of claim 15, wherein the digital file format consists of one or more of the following: a WAV format, an MPEG format, and an AAC format.

18. The car stereo of claim 15, wherein the control circuit is integrated within the auxiliary port.

19. The car stereo of claim 15, wherein the control circuit further comprises a select input to receive a file format select signal that selects one of the plurality of digital file formats to be employed by the control circuit.

20. The car stereo of claim 19, further comprising:
a control input provided on the front surface of the car stereo to generate the file format select signal.

21. A car stereo adapted to be mounted within a vehicle, comprising:
means for communicating with an external portable music player via a wired connection; and
means for transmitting first audio signals received from the portable music player via the means for communicating to one or more loudspeakers mounted within the vehicle.

22. The car stereo of claim 21, wherein the portable music player is adapted to fit in a hand of an occupant of the vehicle.

23. The car stereo of claim 21, wherein the means for communicating comprising an input/output (I/O) port provided on a front surface of the car stereo, the I/O port readily accessible by occupants of the vehicle.

24. The car stereo of claim 21, wherein the means for communicating receives status information from the portable music player via the wired connection.

25. The car stereo of claim 21, wherein the means for communicating provides power to the portable music player via the wired connection.

26. The car stereo of claim 21, further comprising:
an integrated audio playback component having an output to generate second audio signals; and
means for converting the second audio signals into a digital file capable of being stored within the portable music player.

27. The car stereo of claim 27, wherein the means for communicating transmits the digital file to the portable music player via the wired connection.

28. The car stereo of claim 27, wherein the wired connection comprises a fire-wire cable.

29. The car stereo of claim 27, further comprising:
means for selecting which of a plurality of conversion techniques are employed by the means for converting to generate the digital file.

30. The car stereo of claim 29, wherein the means for selecting comprises a control input provided on a front surface of the car stereo.

31. The car stereo of claim 21, further comprising:
means for receiving one or more control signals generated by occupants of the vehicle; and
means for providing the one or more control signals to the portable music player via the wired connection to control various operations of the portable music player.

32. The car stereo of claim 31, wherein the means for receiving comprises a control input provided on a front surface of the car stereo.

33. The car stereo of claim 31, wherein the means for providing comprises the means for communicating.
